(19) United States
(12) Patent Application Publication
(10) Pub. No.: US 2005/0169306 A1
(43) Pub. Date: Aug. 4, 2005

(54) Protocol converter for communication between data processing devices and a data transmission system using said converter

(75) Inventor: Fridolin Faist, Oberwolfach (DE)

Correspondence Address: Gary M. Nath;NATH & ASSOCIATES PLLC, 6th Floor, 1030 15th Street, N.W., Washington, DC, 20005, US

(73) Assignee: VEGA GRIESHABER KG

(21) Appl. No.: 11/094,202

(22) Filed: Mar. 31, 2005

Related U.S. Application Data
(62) Division of application No. 10/209,911, filed on Aug. 2, 2002.

(30) Foreign Application Priority Data
Aug. 9, 2001 (DE) 101 39 245.1

(51) Int. Cl. H04J 3/16

(52) U.S. Cl. 370/466

(57) ABSTRACT

A protocol converter for communication between a first and a second data processing device comprising a first interface for data exchange with the first device according to a modem protocol, and a second interface for data exchange with the second device. The second device is designed for the data exchange according to a packet-oriented protocol, especially the Internet protocol.

### FIELD OF THE INVENTION

The present invention pertains to a protocol converter for communication between a first and a second data processing device comprising a first interface for data exchange with the first device according to a modem protocol, and a second interface for data exchange with the second device.

### BACKGROUND OF THE INVENTION

Each conventional modem represents such a protocol converter. On the one hand, the converter communicates with a first data processing device that is generally a computer to which said converter is directly connected, according to a modem protocol via which commands controlling the mode of operation of the modem are transmitted by the computer to the modem, and data which are to be transmitted from the computer to a remote second data processing device via an intermediate communication network or which are received from said device, are exchanged with the computer.

In connection with such a suitable application program on the computer, this type of modem also allows communication via a package-oriented data transmission network, for example, according to Internet protocol or an e-mail transmission. On the other hand, current communication programs, such as web browsers or e-mail programs, essentially require that a modem or a LAN connection exists through which the computer's communication with a second data processing device can be handled.

Because a large number of people now are familiar with communication programs of this type, there is a wide appeal to use programs of this type also for communicating between a computer and second data processing devices which are not separated by large distances that can be bridged only by remote data transmission networks, but which are located adjacent to each other. Such a requirement may occur, for example, if two data processing devices are transducers or actuators for a process control application. These types of transducers or actuators can be installed at great distances from each other and with a central communication controller, so that as a means of communicating with it, a web browser or an e-mail program can be used for data transmission in connection with a local network or a telecommunication network. The installation or configuration of this type of device, however, becomes problematic if the communication with such devices is possible only via an intermediate modem and a remote data transmission network or a LAN network because if the communication with the device fails, the user will have great difficulty in finding out whether the reason for the failure lies in the second device itself or in the medium used for the communication.

### SUMMARY OF THE INVENTION

In view of the foregoing, it is the object of the present invention to specify a device which enables simple, less failure-prone communication between two data processing devices and above all which simplifies the configuration of the transducers and actuators that are used as second data terminals.

The foregoing object is achieved in the present invention by means of a protocol converter of the aforementioned type, in which the second interface for communication with the second device is designed for the data exchange according to a packet-oriented protocol, especially the Internet protocol. This protocol converter not only can be directly connected to a port of the first data processing device, which is provided for communicating with the modem, but also directly to the second device which communicates according to the packet-oriented protocol, while avoiding an intermediate transmission network. The transmission network thus is excluded as a source of failures between the two data processing devices. Therefore, a user who tries to configure a second data processing device by means of a computer as a first data processing device and the protocol converter of the invention can be certain that the reason for the potentially unexpected behavior of the second device is found in this device or in the information transmitted for configuring said device, but not in the type and transmission manner of this information. Since the behavior of the protocol converter with respect to the first data processing device simulates the behavior of a modem, and if the first data processing device is a computer, this enables the use of the communication programs contained therein, such as browsers or e-mail programs, which require a modem.

In order to set up a connection with the second device via a modem, the first device must transmit in a conventional manner an instruction to the modem in accordance with the modem protocol which specifies the call number under which the second device can be reached. Such a number is not needed if the second device is connected directly to the protocol converter of the invention. Therefore, the protocol converter purposely discards such an instruction and returns a message to the first data terminal, which confirms the setup of a connection with the call number. The communication with the second data terminal is simulated to the first data terminal via a telecommunication connection, which in reality does not occur.

As a result of the first embodiment of the protocol converter, it can be provided that said converter confirms the setup of the connection for any call number that can be specified in the receive instruction. This means that the protocol converter supports the data exchange between the computer and the second data processing device indiscriminately and irrespective of the specific call number. This embodiment gives the user complete assurance that the data, which the computer transmits to a second data terminal after receiving confirmation that the connection has been set up, will actually be relayed.

Alternatively, it can be provided that the protocol converter confirms the connection setup for only a finite number of call numbers that can be specified in the receive instructions. This allows a plurality of protocol converters to be connected in parallel with a computer port and to selectively communicate with a second device which is connected to said protocol converter.

Furthermore, the invention pertains to a data transmission system in which two data processing devices are connected by a protocol converter, as described above.

### BRIEF DESCRIPTION OF THE DRAWINGS

Other features and advantages of the invention result from the following description of the examples which refer to the enclosed figures. Of the figures:

FIGS. 1 and 2 respectively show examples of a data transmission system with a protocol converter according to the present invention.

### DETAILED DESCRIPTION OF THE INVENTION

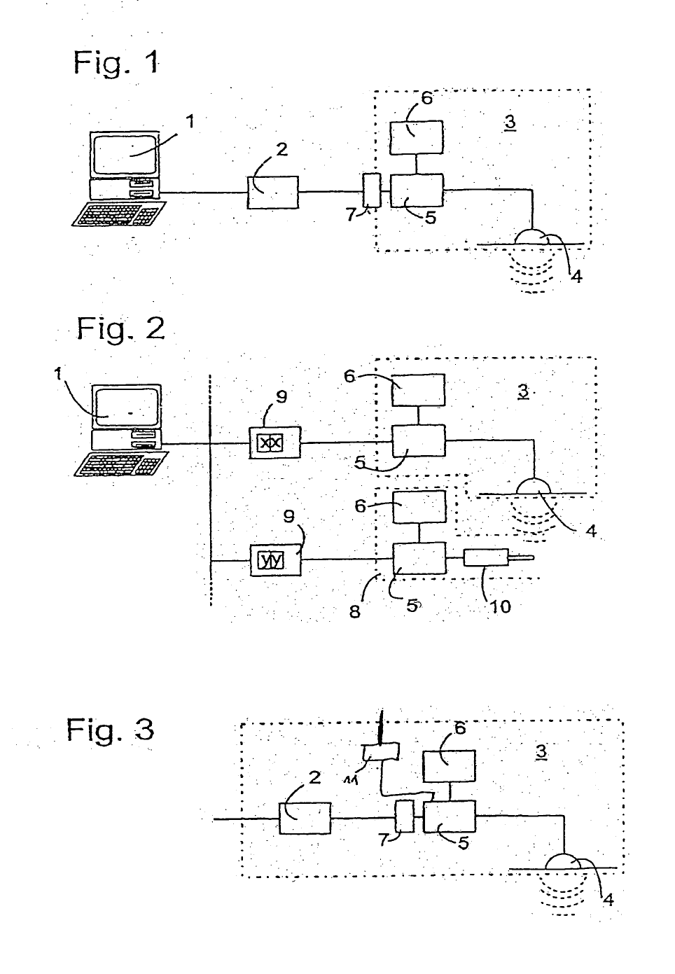

As a first data processing system, the data transmission system shown in FIG. 1 comprises workstation 1 which is connected to protocol converter 2 via a serial interface, such as an RS232 or a USB interface. Such an interface is installed in most workstations for communication with a mouse, a modem or other peripherals. In workstation 1, a communication program such as an e-mail program or a web browser, can be executed to access a modem protocol at the serial interface and the protocol converter via said interface. The communication between the workstation 1 and the protocol converter 2, for example, can be run with a generally known Hayes instruction set.

A second data processing device 3 comprises a sensor 4 for recording a measured quantity and for supplying a signal which is representative of the measured quantity, a microprocessor 5, a memory 6 containing a control program for the microprocessor 5, and one or several text and HTML files, as well as an interface 7 for communicating with the protocol converter 2 that follows the packet orientation protocol, especially the Internet protocol.

Then, in the workstation, a web browser such as Microsoft Internet Explorer or Netscape Navigator, or an e-mail program such as Microsoft Outlook, can be executed.

Such a program requires the existence of a conventional modem at one of the serial ports of the workstation 1 and attempts to respond to a modem, which is expected to exist via this port, in order to set up a connection via a telephone line with the Internet service provider, which is identified by a call number that the workstation 1 outputs in a modem command to the serial port. The protocol converter 2 receives this command. Said converter does not attempt to establish a telecommunication connection since it is not in a position to do so. Instead, the converter transmits a confirmation message to the workstation 1 which simulates to said converter the setup of the desired telecommunication connection. Subsequently, the data can be exchanged between the workstation 1 and the second device 3. Particularly, an HTML page can be transferred from the memory 6 of the workstation 1 in order to form an input mask, as shown by the web browser, into which a user is able to enter the data necessary for the configuration of the device 3. One option for configuring the device 3 is having said device transmit an e-mail of the text stored in the memory 6 to the workstation 1, and as a response to the text shown on the workstation 1, the user inputs a parameter value in the workstation 1 and again sends an e-mail to the device 3.

Therefore, the device 3 can be configured without having to install a special customized program in the device 3 as a part of the workstation 1. This not only saves memory in the workstation 1, but it also ensures that each device 3 to be configured is configured with the correct input mask. This will exclude any errors that may occur by accidentally using a wrong configuration program or a wrong program version.

The protocol converter 2 of FIG. 1 is not selective in terms of the call number signaled by the workstation. This means that irrespective of the call number transmitted by the workstation 1 during a modem command the protocol converter 2 always responds to this command with a confirmation that the connection has been established, and subsequently relays the user data received by the workstation 1 to the connected device 3.

In the example shown in FIG. 2, two second devices 3, 8 are connected to the serial port of the workstation 1 via parallel call number-selective protocol converters 9. Call number selectivity means that the protocol converters 9 respond to a modem command for setting up a connection only when this command contains the call number xx or yy, which is allocated to the protocol converter 9, or contains a plurality of call numbers allocated to said converter. The call number selectivity of the protocol converter allows the parallel operation of several protocol converters on the same serial port of the workstation 1 or a conventional modem parallel to the protocol converters 9. If one of the second devices, in this case the device 8 which is connected to the protocol converters 9, comprises an actuator 10 that is controlled by the microprocessor 5 by means of the commands transmitted to the device, which acts upon the dimension recorded by the sensor 4 of the device 2, the selective response of the two devices 3, 8 is able to test the functionality of said devices in detail.

As shown symbolically in FIG. 3, the second device and the related protocol converter can be combined into a package symbolized by a dash-and-dot rectangle. In such case, it is useful if the package also comprises a connection 11 for the direct communication with the microprocessor 5 according to the package protocol while bypassing the converter 2, so as to ensure the useability of the device both by direct connection with the workstation 1 and by the package network.

In the above-described example, it is assumed that the protocol converter 2 essentially is used in a trial and configuration phase of the second device 3, and that said device communicates with this network according to the package control. However, upon completion of this phase, said network is used in an extended network for monitoring and controlling a production. Of course, upon completion of the test and/or configuration, the second device may continue to be operated via a protocol converter 2 or 9 or used for measuring or control operations if this appears to be appropriate according to the application's geometric marginal conditions.

1-10. (canceled)

11. A data transmission system comprising:
a personal computer and a sensor measuring apparatus connected via a protocol converter with the personal computer,
whereby the protocol converter is connected directly to a serial interface of the personal computer which is prepared for connecting a modem thereto and is connected directly to an interface of the sensor measuring apparatus which communicates according to a packet-oriented protocol, and
whereby the protocol converter discards a web browser instruction which specifies a call number under which the sensor measuring apparatus can be reached and returns to the personal computer a message which confirms, regardless of the call number, a setup of a connection.
